(19) United States
(12) Patent Application Publication
(10) Pub. No.: US 2011/0167114 A1
(43) Pub. Date: Jul. 7, 2011

(54) AUTOMATICALLY SYNCHRONIZING NEW CONTACTS ACROSS MULTIPLE SOCIAL NETWORKING SITES

(75) Inventors: John A. Blanchard, III, Algonquin, IL (US); Jennifer Martin, Chicago, IL (US)

(73) Assignee: INTERNATIONAL BUSINESS MACHINES CORPORATION, Armonk, NY (US)

(21) Appl. No.: 12/652,093

(22) Filed: Jan. 5, 2010

(51) Int. Cl. G06F 17/30; G06F 15/16; G06F 3/01

(52) U.S. Cl. 709/204; 707/610; 707/E17.005; 715/760

(57) ABSTRACT

A method and system for automatically synchronizing a connection to a new contact across a plurality of social networking websites. A repository stores a first user's profile that includes the first user's identifiers for multiple social networking websites (SNs) and the first user's master list of contacts. An alert is presented to the first user, where the alert indicates a request from a second user to establish a connection in a first SN between the first user and the second user. The first user approves the request to establish the connection in the first SN. If a search of the repository finds the second user's profile, then (1) connection(s) between the first user and second user are established in other social networking websites in which said first user participates and (2) the second user is added to the first user's master list of contacts.

### FIELD OF THE INVENTION

The present invention relates to a data processing method and system for managing information on online social networking systems, and more particularly to a technique for automatically synchronizing new contacts across multiple social networking sites.

### BACKGROUND OF THE INVENTION

Numerous social networking websites exist and new ones are being launched frequently. Most people who are social networkers are members of more than one social networking website. The process of building a user's social network is cumbersome, especially when the user is new to a particular social network. To ease the process of building a user's social network, some social networking websites attempt to integrate with e-mail address books. For example, Facebook® enables users to search for people they might know by searching the e-mail address of a validated web e-mail address or by uploading a contact file that has been exported from another application (e.g., from Microsoft® Outlook® or from another social networking website such as LinkedIn®). However, other aspects of building a user's social network on a social networking website and synchronizing information across multiple social networking websites require manual, time-consuming processes. Thus, there exists a need to overcome at least one of the preceding deficiencies and limitations of the related art.

### SUMMARY OF THE INVENTION

In one or more embodiments, the present invention provides a computer-implemented method of synchronizing a connection to a new contact across a plurality of social networking websites. The method comprises:

registering a first user with a repository by storing in the repository a first set of profile information about the first user, wherein the first set of profile information includes a plurality of user identifiers that identify the first user in the plurality of social networking websites, and wherein the first set of profile information further includes a master list of contacts to whom the first user is connected via the repository;

presenting an alert to the first user, wherein the alert indicates a request from a second user to establish a connection in a first social networking website between the first user and the second user;

receiving an approval from the first user to establish the connection between the first user and the second user;

in response to receiving the approval, searching the repository for a second set of profile information about the second user;

in response to searching, finding and retrieving from the repository the second set of profile information about the second user;

subsequent to retrieving, a processor of a computer system establishing one or more other connections between the first user and the second user, wherein the one or more other connections are in one or more other social networking websites, and wherein the one or more other social networking websites are included in the plurality of social networking websites; and

subsequent to retrieving, adding the second user to the master list of contacts to whom the first user is connected via the repository.

In an aspect of an embodiment summarized above, the first set of profile information further includes a set of one or more rules that establish connections between social networking websites. The step of establishing one or more connections includes selecting the one or more other social networking websites as a proper subset of the plurality of social networking websites by applying a rule of the set of one or more rules. The rule being applied relates the first social networking website to the proper subset of the plurality of social networking websites.

A system, program product, and process for supporting computing infrastructure corresponding to the above-summarized method are also described and claimed herein.

Embodiments of the present invention establish an opt-in common repository of linkages between user identifiers (IDs) and social networking websites to which those IDs belong so that propagation of users' relationships across the universe of social networking websites is facilitated.

### BRIEF DESCRIPTION OF THE DRAWINGS

FIG. 1 is a block diagram of a system for automatically synchronizing a connection to a new contact across a plurality of social networking websites, in accordance with embodiments of the present invention.

FIGS. 2A-2B depict a flowchart of a process for automatically synchronizing a connection to a new contact across a plurality of social networking websites, where the process may be implemented in the system of FIG. 1, in accordance with embodiments of the present invention.

FIG. 3 is a computer system that is included in the system of FIG. 1 and that implements the process of FIG. 2, in accordance with embodiments of the present invention.

### DETAILED DESCRIPTION OF THE INVENTION

### Overview

One or more embodiments of the present invention provide a method and system that employs a central repository shared by multiple users. The central repository relates user IDs and social networking sites (e.g., websites) to which those user IDs belong. The multiple users maintain their own information in the central repository and determine who is permitted to access their own information. In response to a first user approving a request to be connected to a second user in a social networking site, the central repository facilitates the synchronization of the first user's connection to the new contact (i.e., the connection to the second user) across all other social networking sites in which the first user participates.

### New Contact Synchronization System

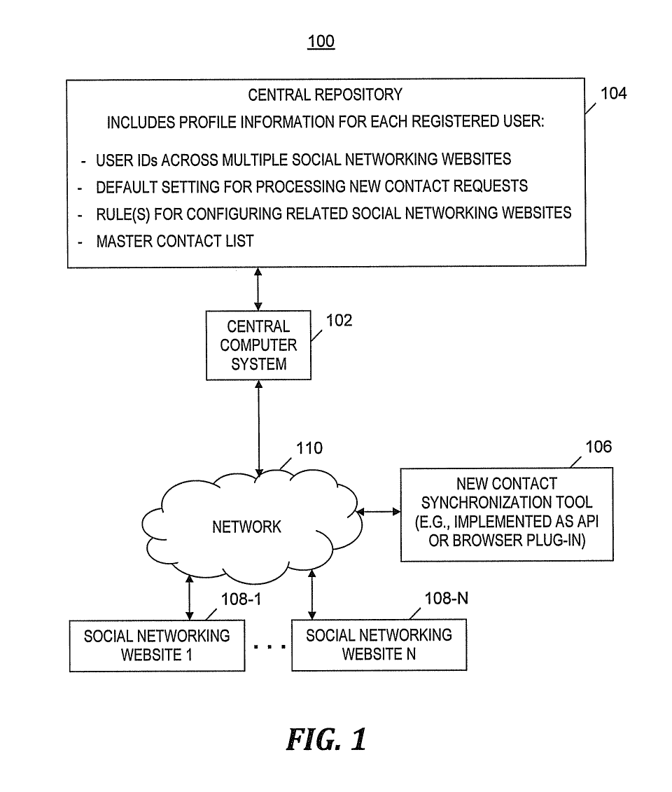

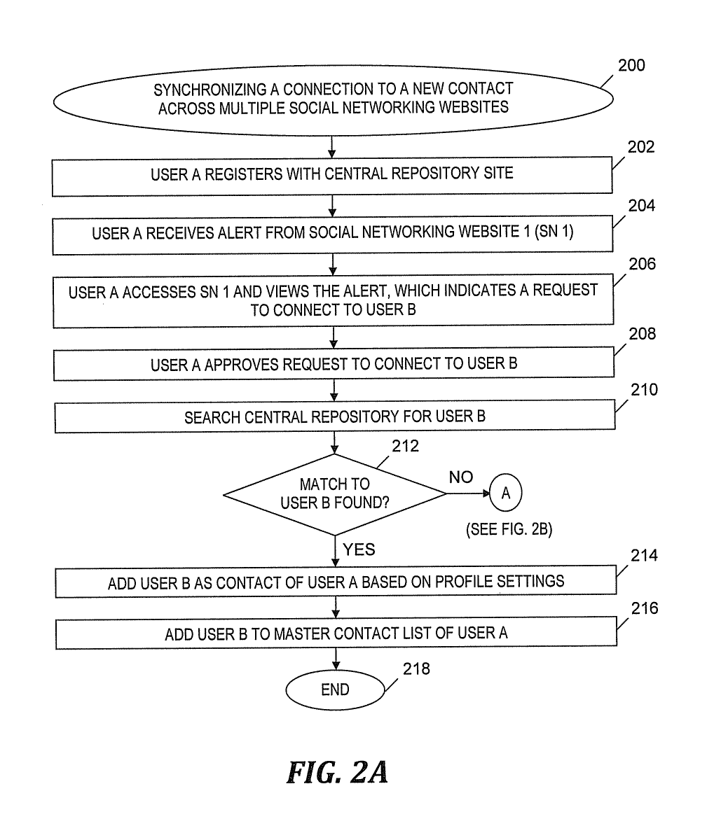

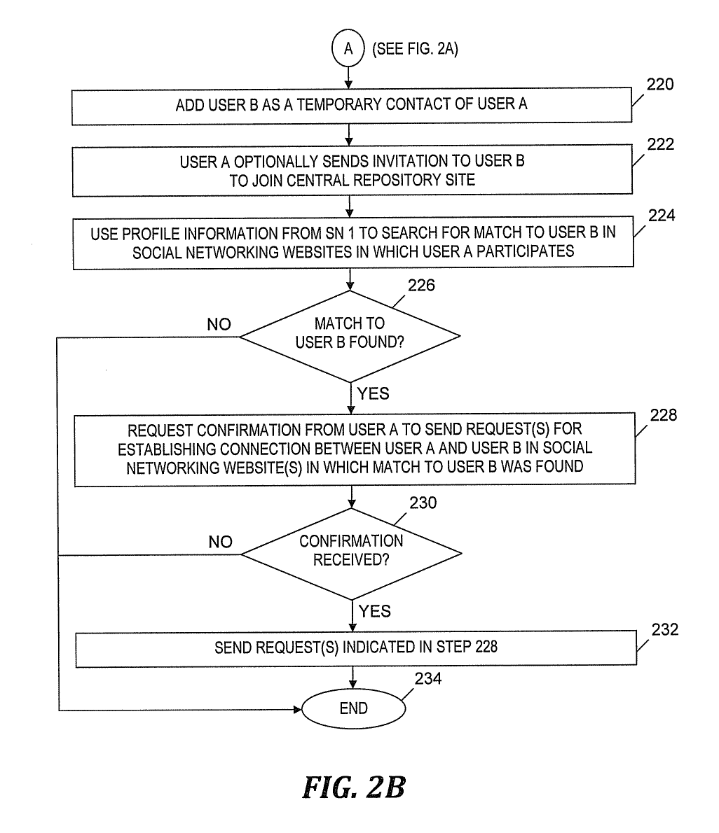

FIG. 1 is a block diagram of a system for automatically synchronizing a connection to a new contact across a plurality of social networking websites, in accordance with embodiments of the present invention. System 100 includes a central computer system 102 coupled to a central data repository 104 (a.k.a. central repository or repository). Central repository 104 stores profile information of multiple users that are registered with the repository. The profile information stored in central repository 104 for each user includes: (1) the user's user IDs for multiple social networking websites in which the user participates; (2) a default setting for processing new contact requests; (3) one or more rules for configuring related social networking websites in which the user participates; and (4) a master contact list (i.e., a list of one or more other users with whom the user has established a connection in a social networking website via the new contact synchronization method described below relative to FIGS. 2A-2B).

The above-listed default setting for processing new contact requests for a user may indicate (1) an automated mode in which a new contact synchronization tool 106 included in system 100 automatically adds connections to the new contact to social networking websites in which the user participates; or (2) a prompt mode in which the tool 106 sends a request (e.g., by email) to the new contact, thereby prompting the new contact to confirm the additions of the aforementioned connections. The social networking websites in which the user participates are included in a plurality of social networking websites 108-1, . . . , 108-N which is included in system 100.

The above-listed one or more rules configure related social networking websites in user-specified groups so that different sub-networks of contacts can be created. For example, the user may group social networking websites into business-oriented sites and non-business oriented sites and establish a rule that indicates contacts in LinkedIn® are automatically added to Xing® because LinkedIn® and Xing® are both business-oriented social networking sites, but are not automatically added to MySpace®, which is a non-business oriented social networking site. LinkedIn® is an online business networking site offered by LinkedIn Corporation located in Mountain View, California. Xing® is an online business networking site offered by Xing AG located in Hamburg, Germany. MySpace® is an online social networking site offered by MySpace, Inc. located in Beverly Hills, Calif.

The tool 106 may be implemented as a plug-in in a web browser installed in a computing device utilized by a user who is registered with the central repository 104, where the user utilizes the web browser to interact with one or more websites of the social networking websites 108-1, . . . , 108-N. The tool 106 may also be implemented as an application programming interface (API) used by a social networking website included in websites 108-1, . . . , 108-N.

In one embodiment, the central repository 104 offers an API that allows social networking websites 108-1, . . . , 108-N to provide enhanced capabilities and to leverage the established interconnections, if authorized by individual users.

### New Contact Synchronization Method

FIGS. 2A-2B depict a flowchart of a process for automatically synchronizing a connection to a new contact across a plurality of social networking websites, where the process may be implemented in the system of FIG. 1, in accordance with embodiments of the present invention. The process for synchronizing a connection to a new contact across multiple social networking websites begins at step 200. In step 202, a first user (a.k.a. User A) registers with the central repository 104 (see FIG. 1). The registration in step 202 includes User A entering or selecting identifications of the social networking websites in which User A participates. The registration in step 202 also includes User A entering her or his user IDs that are utilized to access the social networking websites in which User A participates. Furthermore, the registration in step 202 includes User A entering other profile information (a.k.a. profile settings) that may include default settings for processing new contact requests (e.g., either automatically adding connections to a new contact or prompting the new contact by email or another form of notification to confirm the additions of the connections to the new contact) and/or one or more rules for configuring related social networking websites in which User A participates.

Also in step 202, the central repository 104 (see FIG. 1) stores the information included in the registration in step 202: (1) identifications of the social networking websites in which User A participates, (2) User A's user IDs to access the social networking websites in which User A participates, and (3) the other profile information entered by User A such as the default settings for processing new contact requests and the rule(s) for configuring related social networking websites.

In step 204, User A receives an alert from a first social networking website (a.k.a. SN 1). The alert may be presented to User A in step 204 in a text, audio or any other format that may be comprehended by User A. In one embodiment, the alert received in step 204 is in the form of an email that includes a hyperlink that is selected by User A to log onto SN 1.

In step 206, User A accesses SN 1 via a web browser and views (or otherwise comprehends) additional information in the alert, which indicates a request to establish a connection between User A and a second user (a.k.a. User B) in SN 1.

In step 208, via the web browser accessing SN 1, User A approves the request to establish the connection between User A and User B in SN 1.

In step 210, the new contact synchronization tool 106 (see FIG. 1) searches central repository 104 (see FIG. 1) for a match to profile information that identifies User B. In one embodiment, step 210 includes the tool 106 (see FIG. 1) searching for User B's user ID that accesses SN 1.

In inquiry step 212, if the search in step 210 finds a match to the profile information that identifies User B, then the Yes branch of step 212 is taken and step 214 is performed.

In step 214, tool 106 (see FIG. 1) adds User B as a contact of User A in one or more other social networking websites (i.e., social networking website(s) other than SN 1) in which User A participates. Thus, step 214 synchronizes User A's connection to a new contact (i.e., User B) across multiple social networking websites in which User A participates. Adding User B as a contact of User A in step 214 is based on the profile information stored in the central repository for both User A and User B.

In a first example, User A's default setting stored in central repository 104 (see FIG. 1) indicates an automated mode so that in step 214, the tool 106 (see FIG. 1) automatically adds User B as a contact of User A in the one or more other social networking websites.

In a second example, User A's default setting stored in central repository 104 (see FIG. 1) indicates a prompt mode so that in step 214, the tool 106 (see FIG. 1) sends a request (e.g., via email) to User B to confirm the additions of the connection between User A and User B in the one or more other social networking websites.

In one embodiment, User A entered one or more rules in step 202 that group the social networking websites in which User A participates into multiple groups. For example, User A includes SN 1 and social networking website 2 (SN 2) in Group 1 because SN 1 and SN 2 are business-oriented networking websites, while User A includes social networking website 3 (SN 3) in Group 2 and not in Group 1 because SN 3 is a non-business oriented networking website. In this example, a rule stored in central repository 104 (see FIG. 1) and associated with User A indicates that if a connection is established in step 208 to a new contact in a social networking website in Group 1 (e.g., SN 1), then the connections established in step 214 must be connections between User A and the new contact in all other social networking websites in Group 1 (e.g., SN 2), but not in any social networking website in Group 2 (e.g., SN 3).

In step 216, tool 106 (see FIG. 1) adds User B to the master contact list of User A stored in central repository 104 (see FIG. 1). The process of synchronizing a connection to a new contact across multiple social networking websites ends in step 218.

Returning to inquiry step 212, if the search in step 210 finds no match to the profile information that identifies User B, then the No branch of step 212 is taken and the process of FIGS. 2A-2B continues with step 220 in FIG. 2B. In step 220, tool 106 (see FIG. 1) adds User B as a temporary contact of User A in central repository 104 (see FIG. 1). In step 222, User A optionally sends an invitation to User B to join (i.e., register on) the central repository 104 (see FIG. 1). User B may accept the invitation and register on the central repository 104 (see FIG. 1), thereby providing profile information to the central repository that is similar to the information provided by User A in step 202 (see FIG. 2A). If User B registers on the central repository, then tool 106 (see FIG. 1) changes the status of User B from being a temporary contact of User A in the central repository to being included as a regular contact on User A's master contact list.

In step 224, tool 106 (see FIG. 1) retrieves User B's profile information on SN 1 and uses the retrieved profile information to search for a match to profile information about User B in the one or more other social networking websites (i.e., social networking website(s) other than SN 1) in which User A participates.

In inquiry step 226, if the search in step 224 finds a match to profile information about User B in social networking website(s) (a.k.a. “matched social networking website(s)”) included in the aforementioned one or more other social networking websites in which User A participates, then the Yes branch of step 226 is taken and step 228 is performed.

In step 228, tool 106 (see FIG. 1) requests confirmation from User A to send request(s) for establishing a connection between User A and User B in the matched social networking website(s).

In inquiry step 230, if tool 106 (see FIG. 1) receives the confirmation requested in step 228, then the Yes branch of step 230 is taken and step 232 is performed. In step 232, tool 106 (see FIG. 1) sends the request(s) for establishing a connection between User A and User B, as indicated in step 228. If User B approves the request(s) for establishing the connection, then the connection between User A and User B in SN 1 is synchronized across websites that include SN 1 and the matched social networking website(s). The process of FIGS. 2A-2B ends at step 234.

Returning to inquiry step 226, if the search in step 224 finds no match to profile information about User B in the one or more other social networking websites in which User A participates, then the No branch of step 226 is taken and the process of FIGS. 2A-2B ends at step 234.

Returning to inquiry step 230, if tool 106 (see FIG. 1) if the tool 106 (see FIG. 1) does not receive the confirmation requested in step 228, then the No branch of step 230 is taken and the process of FIGS. 2A-2B ends at step 234.

### Computer System

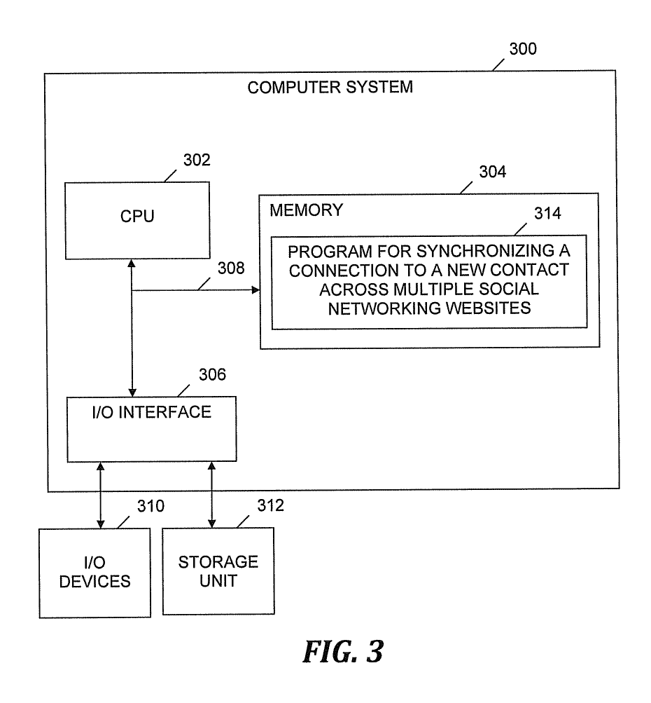

FIG. 3 is a computer system that is included in the system of FIG. 1 and that implements the process of FIG. 2, in accordance with embodiments of the present invention. Computer system 300 generally comprises a central processing unit (CPU) 302, a memory 304, an input/output (I/O) interface 306, and a bus 308. Further, computer system 300 is coupled to I/O devices 310 and a computer data storage unit 312. CPU 302 performs computation and control functions of computer system 300. CPU 302 may comprise a single processing unit, or be distributed across one or more processing units in one or more locations (e.g., on a client and server). In one embodiment, computer system 300 implements new contact synchronization tool 106 (see FIG. 1).

Memory 304 may comprise any known computer readable storage medium, which is described below. In one embodiment, cache memory elements of memory 304 provide temporary storage of at least some program code (e.g., program code 314) in order to reduce the number of times code must be retrieved from bulk storage while instructions of the program code are carried out. Moreover, similar to CPU 302, memory 304 may reside at a single physical location, comprising one or more types of data storage, or be distributed across a plurality of physical systems in various forms. Further, memory 304 can include data distributed across, for example, a local area network (LAN) or a wide area network (WAN).

I/O interface 306 comprises any system for exchanging information to or from an external source. I/O devices 310 comprise any known type of external device, including a display device (e.g., monitor), keyboard, mouse, printer, speakers, handheld device, facsimile, etc. Bus 308 provides a communication link between each of the components in computer system 300, and may comprise any type of transmission link, including electrical, optical, wireless, etc.

I/O interface 306 also allows computer system 300 to store and retrieve information (e.g., data or program instructions such as program code 314) from an auxiliary storage device such as computer data storage unit 312 or another computer data storage unit (not shown). Computer data storage unit 312 may comprise any known computer readable storage medium, which is described below. For example, computer data storage unit 312 may be a non-volatile data storage device, such as a magnetic disk drive (i.e., hard disk drive) or an optical disc drive (e.g., a CD-ROM drive which receives a CD-ROM disk).

Memory 304 may include computer program code 314 that provides the logic for synchronizing new contacts across multiple social networking websites (e.g., the process of FIGS. 2A-2B). In one embodiment, computer program code 314 is included in new contact synchronization tool 106 (see FIG. 1). Further, memory 304 may include other systems not shown in FIG. 3, such as an operating system (e.g., Linux) that runs on CPU 302 and provides control of various components within and/or connected to computer system 300. Still further, memory 304 may include code that provides the logic for a web browser that interacts with social networking website 108-1, . . . , 108-N (see FIG. 1).

Memory 304, storage unit 312, and/or one or more other computer data storage units (not shown) that are coupled to computer system 300 may store profile information included in central repository 104 (see FIG. 1).

As will be appreciated by one skilled in the art, the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “module” or “system” (e.g., system 100 in FIG. 1 or computer system 300). Furthermore, an embodiment of the present invention may take the form of a computer program product embodied in one or more computer readable medium(s) (e.g., memory 304 or computer data storage unit 312) having computer readable program code (e.g., program code 314) embodied or stored thereon.

Any combination of one or more computer readable medium(s) (e.g., memory 304 and computer data storage unit 312) may be utilized. The computer readable medium may be a computer readable signal medium or a computer readable storage medium. A computer readable storage medium may be, for example, but not limited to, an electronic, magnetic, optical, electromagnetic, infrared or semiconductor system, apparatus, device or any suitable combination of the foregoing. A non-exhaustive list of more specific examples of the computer-readable storage medium includes: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with a system, apparatus, or device for carrying out instructions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with a system, apparatus, or device for carrying out instructions.

Program code (e.g., program code 314) embodied on a computer readable medium may be transmitted using any appropriate medium, including but not limited to wireless, wireline, optical fiber cable, RF, etc., or any suitable combination of the foregoing.

Computer program code (e.g., program code 314) for carrying out operations for aspects of the present invention may be written in any combination of one or more programming languages, including an object oriented programming language such as Java®, Smalltalk, C++ or the like and conventional procedural programming languages, such as the “C” programming language or similar programming languages. Instructions of the program code may be carried out entirely on a user's computer, partly on the user's computer, as a stand-alone software package, partly on the user's computer and partly on a remote computer or entirely on the remote computer or server, where the aforementioned user's computer, remote computer and server may be, for example, computer system 300 or another computer system (not shown) having components analogous to the components of computer system 300 included in FIG. 3. In the latter scenario, the remote computer may be connected to the user's computer through any type of network (not shown), including a LAN or a WAN, or the connection may be made to an external computer (e.g., through the Internet using an Internet Service Provider).

Aspects of the present invention are described herein with reference to flowchart illustrations (e.g., FIGS. 2A-2B) and/or block diagrams of methods, apparatus (systems) (e.g., FIG. 1 and FIG. 3), and computer program products according to embodiments of the invention. It will be understood that each block of the flowchart illustrations and/or block diagrams, and combinations of blocks in the flowchart illustrations and/or block diagrams, can be implemented by computer program instructions (e.g., program code 314). These computer program instructions may be provided to a processor (e.g., CPU 302) of a general purpose computer, special purpose computer, or other programmable data processing apparatus to produce a machine, such that the instructions, which are carried out via the processor of the computer or other programmable data processing apparatus, create means for implementing the functions/acts specified in the flowchart and/or block diagram block or blocks.

These computer program instructions may also be stored in a computer readable medium (e.g., memory 304 or computer data storage unit 312) that can direct a computer (e.g., computer system 300), other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer (e.g., computer system 300), other programmable data processing apparatus, or other devices to cause a series of operational steps to be performed on the computer, other programmable apparatus, or other devices to produce a computer implemented process such that the instructions which are carried out on the computer, other programmable apparatus, or other devices provide processes for implementing the functions/acts specified in the flowchart and/or block diagram block or blocks.

Any of the components of an embodiment of the present invention can be deployed, managed, serviced, etc. by a service provider that offers to deploy or integrate computing infrastructure with respect to the process of synchronizing new contacts across multiple social networking websites. Thus, an embodiment of the present invention discloses a process for supporting computer infrastructure, comprising integrating, hosting, maintaining and deploying computer-readable code (e.g., program code 314) into a computer system (e.g., computer system 300), wherein the code in combination with the computer system is capable of performing a process of synchronizing new contacts across multiple social networking websites.

In another embodiment, the invention provides a business method that performs the process steps of the invention on a subscription, advertising and/or fee basis. That is, a service provider, such as a Solution Integrator, can offer to create, maintain, support, etc. a process of synchronizing new contacts across multiple social networking websites. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

The flowchart in FIGS. 2A-2B and the block diagrams in FIG. 1 and FIG. 3 illustrate the architecture, functionality, and operation of possible implementations of systems, methods, and computer program products according to various embodiments of the present invention. In this regard, each block in the flowchart or block diagrams may represent a module, segment, or portion of code (e.g., program code 314), which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A computer-implemented method of synchronizing a connection to a new contact across a plurality of social networking websites, said method comprising:
registering a first user with a repository by storing in said repository a first set of profile information about said first user, wherein said first set of profile information includes a plurality of user identifiers that identify said first user in said plurality of social networking websites, and wherein said first set of profile information further includes a master list of contacts to whom said first user is connected via said repository;
presenting an alert to said first user, wherein said alert indicates a request from a second user to establish a connection in a first social networking website between said first user and said second user;
receiving an approval from said first user to establish said connection between said first user and said second user;
in response to said receiving said approval, searching said repository for a second set of profile information about said second user;
in response to said searching, finding and retrieving from said repository said second set of profile information about said second user;
subsequent to said retrieving, a processor of a computer system establishing one or more other connections between said first user and said second user, wherein said one or more other connections are in one or more other social networking websites, and wherein said one or more other social networking websites are included in said plurality of social networking websites; and
subsequent to said retrieving, adding said second user to said master list of contacts to whom said first user is connected via said repository.

2. The method of claim 1, further comprising:
presenting a second alert to said first user, wherein said second alert indicates a request from a third user to establish a connection in a first social networking website between said first user and said third user;
receiving a second approval from said first user to establish said connection between said first user and said third user;
in response to said receiving said second approval, searching said repository for a third set of profile information about said third user;
in response to said searching for said third set of profile information, determining said repository does not include said third set of profile information about said third user;
subsequent to said determining said repository does not include said third set of profile information, retrieving a profile of said third user from said first social networking website;
searching said one or more other social networking websites for a match to information included in said profile of said third user from said first social networking website;
in response to said searching said one or more other social networking websites, determining said match to said information included in said profile of said third user in a subset of said one or more other social networking websites; and
in response to said determining said match, sending one or more requests to establish a connection between said first user and said third user in each social networking website of said subset of one or more other social networking websites.

3. The method of claim 2, further comprising adding said third user as a temporary contact of said first user in said repository.

4. The method of claim 2, further comprising sending an invitation to said third user to register with said repository.

5. The method of claim 1, wherein said first set of profile information further includes a default setting for processing a request to establish a connection in a social networking website between said first user and another user, and wherein said default setting is a mode selected from the group consisting of an automated mode and a prompt mode.

6. The method of claim 5, wherein said default setting is said automated mode, and wherein said establishing one or more other connections between said first user and said second user includes automatically establishing said one or more other connections between said first user and said second user in said one or more other social networking websites based on said default setting being said automated mode, and without prompting said second user to confirm said one or more other connections.

7. The method of claim 5, wherein said default setting is said prompt mode, and wherein said establishing one or more other connections between said first user and said second user includes prompting said second user to confirm each connection of said one or more other connections.

8. The method of claim 1, wherein said first set of profile information further includes a set of one more rules that establish a connection in a social networking website between said first user and another user, and wherein said establishing one or more other connections includes selecting said one or more other social networking websites as a proper subset of said plurality of social networking websites by applying a rule of said set of one or more rules that relates said first social networking website to said proper subset of said plurality of social networking websites.

9. A computer system comprising:
a processor; and
a computer-readable memory unit coupled to said processor, said memory unit containing instructions executable by said processor to implement a method of synchronizing a connection to a new contact across a plurality of social networking websites, said method comprising:
registering a first user with a repository by storing in said repository a first set of profile information about said first user, wherein said first set of profile information includes a plurality of user identifiers that identify said first user in said plurality of social networking websites, and wherein said first set of profile information further includes a master list of contacts to whom said first user is connected via said repository;
presenting an alert to said first user, wherein said alert indicates a request from a second user to establish a connection in a first social networking website between said first user and said second user;
receiving an approval from said first user to establish said connection between said first user and said second user;
in response to said receiving said approval, searching said repository for a second set of profile information about said second user;
in response to said searching, finding and retrieving from said repository said second set of profile information about said second user;
subsequent to said retrieving, establishing one or more other connections between said first user and said second user, wherein said one or more other connections are in one or more other social networking websites, and wherein said one or more other social networking websites are included in said plurality of social networking websites; and
subsequent to said retrieving, adding said second user to said master list of contacts to whom said first user is connected via said repository.

10. The system of claim 9, wherein said method further comprises:
presenting a second alert to said first user, wherein said second alert indicates a request from a third user to establish a connection in a first social networking website between said first user and said third user;
receiving a second approval from said first user to establish said connection between said first user and said third user;
in response to said receiving said second approval, searching said repository for a third set of profile information about said third user;
in response to said searching for said third set of profile information, determining said repository does not include said third set of profile information about said third user;
subsequent to said determining said repository does not include said third set of profile information, retrieving a profile of said third user from said first social networking website;
searching said one or more other social networking websites for a match to information included in said profile of said third user from said first social networking website;
in response to said searching said one or more other social networking websites, determining said match to said information included in said profile of said third user in a subset of said one or more other social networking websites; and
in response to said determining said match, sending one or more requests to establish a connection between said first user and said third user in each social networking website of said subset of one or more other social networking websites.

11. The system of claim 10, wherein said method further comprises adding said third user as a temporary contact of said first user in said repository.

12. The system of claim 10, wherein said method further comprises sending an invitation to said third user to register with said repository.

13. The system of claim 9, wherein said first set of profile information further includes a default setting for processing a request to establish a connection in a social networking website between said first user and another user, and wherein said default setting is a mode selected from the group consisting of an automated mode and a prompt mode.

14. The system of claim 13, wherein said default setting is said automated mode, and wherein said establishing one or more other connections between said first user and said second user includes automatically establishing said one or more other connections between said first user and said second user in said one or more other social networking websites based on said default setting being said automated mode, and without prompting said second user to confirm said one or more other connections.

15. The system of claim 13, wherein said default setting is said prompt mode, and wherein said establishing one or more other connections between said first user and said second user includes prompting said second user to confirm each connection of said one or more other connections.

16. The system of claim 9, wherein said first set of profile information further includes a set of one more rules that establish a connection in a social networking website between said first user and another user, and wherein said establishing one or more other connections includes selecting said one or more other social networking websites as a proper subset of said plurality of social networking websites by applying a rule of said set of one or more rules that relates said first social networking website to said proper subset of said plurality of social networking websites.

17. A computer program product comprising:
a computer readable storage medium having a computer readable program code stored therein, said computer readable program code containing instructions executable by a processor of a computer system to implement a method of synchronizing a connection to a new contact across a plurality of social networking websites, said method comprising:
registering a first user with a repository by storing in said repository a first set of profile information about said first user, wherein said first set of profile information includes a plurality of user identifiers that identify said first user in said plurality of social networking websites, and wherein said first set of profile information further includes a master list of contacts to whom said first user is connected via said repository;
presenting an alert to said first user, wherein said alert indicates a request from a second user to establish a connection in a first social networking website between said first user and said second user;
receiving an approval from said first user to establish said connection between said first user and said second user;
in response to said receiving said approval, searching said repository for a second set of profile information about said second user;
in response to said searching, finding and retrieving from said repository said second set of profile information about said second user;
subsequent to said retrieving, establishing one or more other connections between said first user and said second user, wherein said one or more other connections are in one or more other social networking websites, and wherein said one or more other social networking websites are included in said plurality of social networking websites; and
subsequent to said retrieving, adding said second user to said master list of contacts to whom said first user is connected via said repository.

18. The program product of claim 17, wherein said method further comprises:
presenting a second alert to said first user, wherein said second alert indicates a request from a third user to establish a connection in a first social networking website between said first user and said third user;
receiving a second approval from said first user to establish said connection between said first user and said third user;
in response to said receiving said second approval, searching said repository for a third set of profile information about said third user;
in response to said searching for said third set of profile information, determining said repository does not include said third set of profile information about said third user;
subsequent to said determining said repository does not include said third set of profile information, retrieving a profile of said third user from said first social networking website;
searching said one or more other social networking websites for a match to information included in said profile of said third user from said first social networking website;
in response to said searching said one or more other social networking websites, determining said match to said information included in said profile of said third user in a subset of said one or more other social networking websites; and
in response to said determining said match, sending one or more requests to establish a connection between said first user and said third user in each social networking website of said subset of one or more other social networking websites.

19. The program product of claim 18, wherein said method further comprises adding said third user as a temporary contact of said first user in said repository.

20. The program product of claim 18, wherein said method further comprises sending an invitation to said third user to register with said repository.

21. The program product of claim 17, wherein said first set of profile information further includes a default setting for processing a request to establish a connection in a social networking website between said first user and another user, and wherein said default setting is a mode selected from the group consisting of an automated mode and a prompt mode.

22. The program product of claim 21, wherein said default setting is said automated mode, and wherein said establishing one or more other connections between said first user and said second user includes automatically establishing said one or more other connections between said first user and said second user in said one or more other social networking websites based on said default setting being said automated mode, and without prompting said second user to confirm said one or more other connections.

23. The program product of claim 21, wherein said default setting is said prompt mode, and wherein said establishing one or more other connections between said first user and said second user includes prompting said second user to confirm each connection of said one or more other connections.

24. A process for supporting computing infrastructure, said process comprising providing at least one support service for at least one of creating, integrating, hosting, maintaining, and deploying computer-readable code in a computer system, wherein the code in combination with the computer system is capable of performing a method of synchronizing a connection to a new contact across a plurality of social networking websites, said method comprising:
registering a first user with a repository by storing in said repository a first set of profile information about said first user, wherein said first set of profile information includes a plurality of user identifiers that identify said first user in said plurality of social networking websites, and wherein said first set of profile information further includes a master list of contacts to whom said first user is connected via said repository;
presenting an alert to said first user, wherein said alert indicates a request from a second user to establish a connection in a first social networking website between said first user and said second user;
receiving an approval from said first user to establish said connection between said first user and said second user;
in response to said receiving said approval, searching said repository for a second set of profile information about said second user;
in response to said searching, finding and retrieving from said repository said second set of profile information about said second user;
subsequent to said retrieving, a processor of said computer system establishing one or more other connections between said first user and said second user, wherein said one or more other connections are in one or more other social networking websites, and wherein said one or more other social networking websites are included in said plurality of social networking websites; and
subsequent to said retrieving, adding said second user to said master list of contacts to whom said first user is connected via said repository.

25. The process of claim 24, wherein said method further comprises:
presenting a second alert to said first user, wherein said second alert indicates a request from a third user to establish a connection in a first social networking website between said first user and said third user;
receiving a second approval from said first user to establish said connection between said first user and said third user;
in response to said receiving said second approval, searching said repository for a third set of profile information about said third user;
in response to said searching for said third set of profile information, determining said repository does not include said third set of profile information about said third user;
subsequent to said determining said repository does not include said third set of profile information, retrieving a profile of said third user from said first social networking website;
searching said one or more other social networking websites for a match to information included in said profile of said third user from said first social networking website;
in response to said searching said one or more other social networking websites, determining said match to said information included in said profile of said third user in a subset of said one or more other social networking websites; and
in response to said determining said match, sending one or more requests to establish a connection between said first user and said third user in each social networking website of said subset of one or more other social networking websites.
